(19) United States
(12) Patent Application Publication
(10) Pub. No.: US 2025/0393101 A1
(43) Pub. Date: Dec. 25, 2025

(54) REGULATING THE USE OF PAGING DURING EMERGENCY SESSIONS IN A TELECOMMUNICATIONS NETWORK

(71) Applicant: HUAWEI TECHNOLOGIES CO., LTD., Shenzhen (CN)

(72) Inventors: Jagdeep Singh Ahluwalia, Reading (GB); Xi Xie, Beijing (CN); Junren Chang, Beijing (CN); Feng Han, Shanghai (CN); Rui Wang, Shanghai (CN)

(73) Assignee: HUAWEI TECHNOLOGIES CO., LTD., Shenzhen (CN)

(21) Appl. No.: 19/294,654

(22) Filed: Aug. 8, 2025

Related U.S. Application Data
(63) Continuation of application No. PCT/CN2023/075390, filed on Feb. 10, 2023.

(51) Int. Cl. H04W 76/50; H04W 52/02; H04W 68/02; H04W 76/28

(52) U.S. Cl. CPC H04W 76/50; H04W 52/0229; H04W 68/02; H04W 76/28

(57) ABSTRACT

In some embodiments, a network apparatus in a telecommunications network, wherein the telecommunications network comprises at least one core network and at least one network node, can be configured to receive data comprising an indication to disable, enable or reenable the use of at least one network operation of the network apparatus for a user equipment, UE, wherein the user equipment, UE, is in a radio resource control, RRC, idle or inactive state of operation, and wherein the user equipment, UE, is participating in an active Packet Data Unit, PDU, or Evolved Universal Terrestrial Radio Access Network, E-UTRAN, Radio Access Bearer, E-RAB, session for an emergency call, and use the received data to disable, enable or reenable the at least one network operation.

### CROSS-REFERENCE TO RELATED APPLICATIONS

This application is a continuation of International Application No. PCT/CN2023/075390, filed on Feb. 10, 2023, the disclosure of which is hereby incorporated by reference in its entirety.

### TECHNICAL FIELD

The present disclosure relates, in general, to paging in a telecommunications network. Aspects relate to regulation of paging during emergency sessions between a user equipment and the network.

### BACKGROUND

Third generation partnership project (3GPP) and fifth generation (5G) New Radio (NR) mobile telecommunication networks provide high data rate, low latency and improved system performances. In 3GPP NR, 5G terrestrial NR access networks include multiple network apparatus such as network nodes or base stations, e.g., Next Generation Node-Bs (gNBs) that communicate with mobile stations referred as user equipment (UE).

In order to set up channels for communication between a UE and a gNB, a procedure called paging is used in which the telecommunications network determines the location of the UE before actual connection establishment. Paging is used to alert the UE of an incoming session (e.g., call) and in most cases the paging process is implemented while a UE is in radio resource control (RRC) idle mode. During an RRC idle mode of operation, a UE can be in a sleep (i.e., low power consumption) mode defined by a discontinuous reception (DRX) or extended DRX (eDRX) cycle in which the UE periodically wakes and monitors a Physical Downlink Control Channel (PDCCH) of the network, which is used for downlink scheduling, to check for the presence of a paging message. If the PDCCH indicates that a paging message is transmitted in a subframe, then the UE demodulates the paging channel to see if the paging message is directed to it. This means that the UE has to monitor whether the network is transmitting paging messages to it.

In a 5G network for example, a packet data unit (PDU) session is used to provide end-to-end user plane connectivity between a UE and a specific Data Network (DN) through the User Plane Function (UPF). It is similar, in concept, to a Packet Data Network (PDN) connection in a 4G Evolved Packet Core (EPC) network. A PDU Session provides connectivity between applications on a UE and a DN such as the ‘Internet’ or private corporate networks for example. An emergency PDU session provides connectivity between a UE and an emergency service. For example, an emergency PDU session can enable a UE to communicate with an emergency service or call centre. Whilst active, an emergency PDU session between a UE and an emergency service or call centre will be maintained and over the course of an emergency PDU session, a UE may make and/or receive multiple calls to an emergency service or call centre. That is, an emergency PDU session may comprise follow up communications between a UE and an emergency service or call centre in addition to an initial call (which can comprise a call or communication that triggered the emergency PDU session). For example, an emergency service may contact the UE after an initial call in order to, e.g., obtain more information from the user of the UE about the emergency situation. Any subsequent communications, such as follow up calls for example, belong to the same active emergency PDU session. The network can initiate such communications by paging the UE after it goes into an RRC idle or inactive state of operation. For example, once an initial emergency call has been terminated, the UE can go into an RRC idle or inactive state of operation. In order for a follow up communication to be established, the network will page the UE in order to establish the subsequent communication.

### SUMMARY

An objective of the present disclosure is to provide apparatus and methods to regulate the use of network operations in a telecommunications network, such as a paging operation for example, particularly during an emergency packet data unit session.

The foregoing and other objectives are achieved by the features of the independent claims.

Further implementation forms are apparent from the dependent claims, the description and the Figures.

A first aspect of the present disclosure provides a network apparatus in a telecommunications network, wherein the telecommunications network comprises at least one core network and at least one network node, the network apparatus configured to receive data comprising an indication to disable, enable or reenable the use of at least one network operation of the network apparatus for a user equipment, UE, wherein the user equipment, UE, is in a radio resource control, RRC, idle or inactive state of operation, and wherein the user equipment, UE, is participating in an active Packet Data Unit, PDU, or Evolved Universal Terrestrial Radio Access Network, E-UTRAN, Radio Access Bearer, E-RAB, session for an emergency call, and use the received data to disable, enable or reenable the at least one network operation.

In a situation in which an emergency PDU session is established, follow up calls could be initiated following an initial emergency call. Disabling, enabling or reenabling the use of at least one network operation, such as paging for example, allows the network apparatus, such as a gNB or eNB for example, to become aware that it should not use, e.g., Paging Early Indication, PEI and User Equipment Identifier, UE ID based subgrouping when it receives paging from a CN component during an active emergency PDU session. Accordingly, the issue that a network apparatus such as a gNB/eNB is not aware that the emergency PDU session is active is solved, and it is therefore able to avoid the use of PEI and UE ID based subgrouping when it receives paging from CN during such an active emergency PDU session.

In an embodiment, the network operation can comprise at least one of a Paging Early Indication, PEI, the Paging Early Indication, PEI, comprising a user equipment, UE, identifier, UEID, based sub grouping; extended discontinuous reception, eDRX; a Wake Up Signal, WUS; or a Group Wake up Signal, GWUS. The network apparatus can receive the data from the at least one core network of the telecommunications network or from the at least one network node. The network apparatus can receive the data from the at least one core network of the telecommunications network as part of a paging message.

In an embodiment, the network apparatus can receive the data from the at least one core network of the telecommunications network as part of a paging message for an emergency call back to be received by the UE as part of the active Packet Data Unit, PDU, or Evolved Universal Terrestrial Radio Access Network, E-UTRAN, Radio Access Bearer, E-RAB, session for an emergency call.

The network apparatus can transmit, to the user equipment, UE, a paging message as part of the Packet Data Unit, PDU, or Evolved Universal Terrestrial Radio Access Network, E-UTRAN, Radio Access Bearer, E-RAB, session for the emergency call, wherein the paging message is transmitted without a paging early indication, PEI, and/or a user equipment, UE, identifier, UEID, relating to a sub-grouping for the user equipment, UE. The data can comprise part of a downlink, DL, non-access stratum, NAS, message from at least one core network of the telecommunications network.

The network apparatus can receive the data comprising an indication to disable the use of paging early indication, PEI, extended discontinuous reception, eDRX, a wake-up signal, WUS, or a Group Wake up Signal, GWUS for the user equipment, UE, when establishing the emergency call for the user equipment, UE, as part of a packet data unit, PDU, or Evolved Universal Terrestrial Radio Access Network, E-UTRAN, Radio Access Bearer, E-RAB, session acceptance message transmitted by the at least one core network of the telecommunications network. The network apparatus can receive the data comprising an indication to reenable the use of paging early indication, PEI, extended discontinuous reception, eDRX, a wake-up signal, WUS, or a Group Wake up Signal, GWUS for the user equipment, UE, when releasing the emergency call for the user equipment, UE, as part of a packet data unit, PDU, or Evolved Universal Terrestrial Radio Access Network, E-UTRAN, Radio Access Bearer, E-RAB, session release message transmitted by the at least one core network of the telecommunications network.

In an embodiment, the network apparatus can comprise a functionally split network apparatus comprising a central unit, CU, and a distribution unit, DU, wherein the network apparatus is configured to receive the data from the at least one core network of the telecommunications network using a F1 interface configured between the CU and the DU.

Accordingly, the network apparatus, such as a gNB, can be functionally split into two or more parts. For example, a radio hardware unit (RU) can be used to convert radio signals sent to and from an antenna of the network apparatus into a digital signal for transmission over packet networks. It can thus deal with the digital front end (DFE) and the lower physical (PHY) layer, as well as digital beamforming functionality.

A distributed unit (DU) can comprise a component for the network apparatus that can be, e.g., deployed close to the RU on site and which executes the radio link control (RLC), medium access control (MAC) layers, and parts of the PHY layer. The central unit (CU) can comprise radio resource control (RRC), Service Data Adaptation Protocol (SDAP), and Packet Data Convergence Protocol (PDCP) protocol layers, and can be responsible for non-real-time RRC, PDCP protocol stack functions. In an embodiment, the CU can be deployed in a cloud environment to support an integrated deployment of a core network user plane function (UPF) sinking and edge computing. The CU and DU can be connected using an F1 interface. The F1 interface is the functional split of 3GPP between the CU (centralized unit: PDCP, RRC, SDAP) and the DU (distributed unit: RLC, MAC, PHY). It is standardized in TS 38.470-38.473 for 5G NR.

One CU can manage one or more DUs. In general, the DU is responsible for real time layer 1 (L1, physical layer) and lower layer 2 (L2) which contains the data link layer and scheduling function. The CU is responsible for non-real time, higher L2 and L3 (network layer) functions.

A second aspect of the present disclosure provides a core network apparatus of a telecommunications network, wherein the telecommunications network comprises at least one core network and at least one network node, the core network apparatus configured to transmit, to a network apparatus of the telecommunications network, data comprising an indication to disable, enable or reenable use of at least one network operation for a user equipment, UE, wherein the UE is in a radio resource control, RRC, idle or inactive state of operation, and wherein the UE is participating in an active session for an emergency call.

The core network apparatus can comprise an access mobility function (AMF) or Mobility Management Entity (MME) for the network for example. The active session for an emergency call can comprise an active Packet Data Unit, PDU, or Evolved Universal Terrestrial Radio Access Network, E-UTRAN, Radio Access Bearer, E-RAB, session for an emergency call, and wherein the network operation comprises at least one of a paging early indication, PEI, the paging early indication, PEI, comprising a user equipment, UE, identifier, UEID, based sub grouping; extended discontinuous reception, eDRX; a Wake Up Signal, WUS; or a Group Wake up Signal, GWUS.

In an embodiment, the core network apparatus can transmit the data as part of a paging message for an emergency call back to be received by the user equipment, UE, as part of the Packet Data Unit, PDU, or Evolved Universal Terrestrial Radio Access Network, E-UTRAN, Radio Access Bearer, E-RAB, session for an emergency call. The core network apparatus can transmit the data comprising an indication to disable, enable, or reenable the at least one network operation as part of a downlink, DL, non-access stratum, NAS, message.

A third aspect of the present disclosure provides user equipment, wherein the user equipment, UE, is participating in an active Packet Data Unit, PDU, or Evolved Universal Terrestrial Radio Access Network, E-UTRAN, Radio Access Bearer, E-RAB, session for an emergency call, the user equipment, UE, configured to receive data, from a network apparatus in a telecommunications network, wherein the telecommunications network comprises at least one core network and at least one network node, the data representing an indication of the establishment or release of the emergency call, and transmit data, to the at least one core network of the telecommunications network and to the at least one network node, to disable or enable the use of paging early indication and paging subgrouping for the user equipment, UE, the data provided as part of a user equipment, UE, capability information message.

These and other aspects of the disclosure will be apparent from the embodiment(s) described below.

### BRIEF DESCRIPTION OF THE DRAWINGS

In order that the present disclosure may be more readily understood, embodiments will now be described, by way of example, with reference to the accompanying drawings, in which:

FIG. 1 is a communication flow according to an embodiment between a UE, at least one core network function of a telecommunications network and at least one network node of the telecommunications network;

FIG. 2 is a communication flow according to an embodiment in which a CN function, such as an AMF, uses an indication in a DL NAS transport message when the CN sends the DL NAS message to a network apparatus, such as a gNB, when the UE is in an RRC INACTIVE mode of operation;

FIG. 3 is a communication flow according to an embodiment in which a CN function, such as an AMF or MME, uses an indication in a DL NAS transport message when an emergency PDU session is established or released for a UE in an RRC IDLE state of operation;

FIG. 4 is a communication flow according to an embodiment in which a CN function, such as an AMF, uses an indication in a DL NAS transport message when an emergency PDU session is established or released for a UE in an RRC INACTIVE state of operation;

FIG. 5 is a communication flow according to an embodiment in which a UE Initiated Dynamic Capability Update is used during an emergency PDU session before the UE is transitioned into an RRC IDLE state of operation;

FIG. 6 is a communication flow according to an embodiment in which a UE Initiated Dynamic Capability Update is used during an emergency PDU session before the UE is transitioned into an RRC INACTIVE state of operation; and

FIG. 7 is a schematic representation of a machine according to an embodiment.

### DETAILED DESCRIPTION

Example embodiments are described below in sufficient detail to enable those of ordinary skill in the art to embody and implement the systems and processes herein described. It is important to understand that embodiments can be provided in many alternate forms and should not be construed as limited to the examples set forth herein.

Accordingly, while embodiments can be modified in various ways and take on various alternative forms, specific embodiments thereof are shown in the drawings and described in detail below as examples. There is no intent to limit to the particular forms disclosed. On the contrary, all modifications, equivalents, and alternatives falling within the scope of the appended claims should be included. Elements of the example embodiments are consistently denoted by the same reference numerals throughout the drawings and detailed description where appropriate.

The terminology used herein to describe embodiments is not intended to limit the scope. The articles “a,” “an,” and “the” are singular in that they have a single referent, however the use of the singular form in the present document should not preclude the presence of more than one referent. In other words, elements referred to in the singular can number one or more, unless the context clearly indicates otherwise. It will be further understood that the terms “comprises,” “comprising,” “includes,” and/or “including,” when used herein, specify the presence of stated features, items, steps, operations, elements, and/or components, but do not preclude the presence or addition of one or more other features, items, steps, operations, elements, components, and/or groups thereof. The term “and/or” is only an association relationship for describing associated objects and represents that three relationships may exist such that A and/or B may indicate that A exists alone, A and B exist at the same time, or B exists alone. The character “/” generally represents that the associated objects are in an “or” relationship.

Unless otherwise defined, all terms (including technical and scientific terms) used herein are to be interpreted as is customary in the art. It will be further understood that terms in common usage should also be interpreted as is customary in the relevant art and not in an idealized or overly formal sense unless expressly so defined herein.

The following contains specific information related to implementations of the present disclosure. The drawings and their accompanying detailed disclosure are merely directed to implementations. However, the present disclosure is not limited to these implementations. Other variations and implementations of the present disclosure will be obvious to those skilled in the art.

The phrases “in one implementation,” or “in some implementations,” may each refer to one or more of the same or different implementations. The term “coupled” is defined as connected whether directly or indirectly through intervening components and is not necessarily limited to physical connections. The expression “at least one of A, B and C” or “at least one of the following: A, B and C” means “only A, or only B, or only C, or any combination of A, B and C.”

The terms “system” and “network” may be used interchangeably.

For the purposes of explanation and non-limitation, specific details such as functional entities, techniques, protocols, and standards are set forth for providing an understanding of the present disclosure. In other examples, detailed disclosure of well-known methods, technologies, systems, and architectures are omitted so as not to obscure the present disclosure with unnecessary details.

Persons skilled in the art will immediately recognize that any network function(s) or algorithm(s) disclosed may be implemented by hardware, software or a combination of software and hardware. Disclosed functions may correspond to modules which may be software, hardware, firmware, or any combination thereof.

A software implementation may include machine- and/or computer-readable and/or executable instructions stored on a machine- and/or computer-readable medium such as memory or other types of storage devices. One or more microprocessors or general-purpose computers with communication processing capability may be programmed with corresponding executable instructions and perform the disclosed network function(s) or algorithm(s).

The microprocessors or general-purpose computers may include Applications Specific Integrated Circuitry (ASIC), programmable logic arrays, and/or using one or more Digital Signal Processor (DSPs). Although some of the disclosed implementations are oriented to software installed and executing on computer hardware, alternative implementations implemented as firmware or as hardware or as a combination of hardware and software are well within the scope of the present disclosure. The computer readable medium includes but is not limited to Random Access Memory (RAM), Read Only Memory (ROM), Erasable Programmable Read-Only Memory (EPROM), Electrically Erasable Programmable Read-Only Memory (EEPROM), flash memory, Compact Disc Read-Only Memory (CD-ROM), magnetic cassettes, magnetic tape, magnetic disk storage, or any other equivalent medium capable of storing computer-readable instructions.

A radio communication network architecture such as a Long-Term Evolution (LTE) system, an LTE-Advanced (LTE-A) system, an LTE-Advanced Pro system, or a 5G NR Radio Access Network (RAN) typically includes at least one base station (BS), at least one user equipment (UE), and one or more optional network elements that provide connection within a network. The UE communicates with the network such as a Core Network (CN), an Evolved Packet Core (EPC) network, an Evolved Universal Terrestrial RAN (E-UTRAN), a 5G Core (5GC), or an internet via a RAN established by one or more BSs.

A UE may include but is not limited to a mobile station, a mobile terminal or device, or a user communication radio terminal. The UE may be a portable radio equipment that includes but is not limited to a mobile phone, a tablet, a wearable device, a sensor, a vehicle, or a Personal Digital Assistant (PDA) with wireless communication capability. The UE is configured to receive and transmit signals using one or more signalling radio bearers over an air interface to one or more cells in a RAN using one or more of multiple component carriers.

A BS can provide communication services according to at least a Radio Access Technology (RAT) such as Worldwide Interoperability for Microwave Access (WiMAX), Global System for Mobile communications (GSM) that is often referred to as 2G, GSM Enhanced Data rates for GSM Evolution (EDGE) RAN (GERAN), General Packet Radio Service (GPRS), Universal Mobile Telecommunication System (UMTS) that is often referred to as 3G based on basic wideband-code division multiple access (W-CDMA), high-speed packet access (HSPA), LTE, LTE-A, evolved LTE (eLTE) that is LTE connected to 5GC, NR (often referred to as 5G), and/or LTE-A Pro. However, the scope of the present disclosure is not limited to these protocols.

A BS may include but is not limited to a node B (NB) in the UMTS, an evolved node B (eNB) in LTE or LTE-A, a radio network controller (RNC) in UMTS, a BS controller (BSC) in the GSM/GERAN, a next generation (ng)-eNB in an Evolved Universal Terrestrial Radio Access (E-UTRA) BS in connection with 5GC, a next generation Node B (gNB) in the 5G-RAN, or any other apparatus capable of controlling radio communication and managing radio resources within a cell. A BS may serve one or more UEs via a radio interface.

A BS can provide radio coverage to a specific geographical area using a plurality of cells forming the RAN. The BS supports the operations of the cells. Each cell is operable to provide services to at least one UE within its radio coverage.

Each cell (often referred to as a serving cell) can provide services to serve one or more UEs within its radio coverage such that each cell schedules the downlink (DL) and optionally uplink (UL) resources to at least one UE within its radio coverage for DL and optionally UL packet transmissions. The BS can communicate with one or more UEs in the radio communication system via the plurality of cells. A cell may allocate sidelink (SL) resources for supporting Proximity Service (ProSe) or Vehicle to Everything (V2X) service. Each cell may have overlapped coverage areas with other cells.

As noted above, an emergency PDU session can result in a UE being paged following termination of an initial communication in order to enable a follow up communication as part of the still active emergency PDU session to be initiated. As noted for example, the active emergency PDU session may comprise follow up communications between the UE and an emergency service or call centre. However, since PDU sessions, and thus emergency PDU sessions are established and terminated by a CN component of the network, any network apparatus such as a node or base station (e.g., a gNB or eNB) that has been involved in serving the UE party to the emergency PDU session will be unaware that such a session is active. Accordingly, the node for example will be unaware that it should refrain from paging the UE using, for example, one of a Paging Early Indication, PEI, with a user equipment, UE, identifier, UEID, based sub grouping for example; extended discontinuous reception, eDRX; a Wake Up Signal, WUS; or a Group Wake up Signal, GWUS.

According to an embodiment, there are provided systems, methods and apparatuses configured to disable, enable or reenable the at least one network operation, wherein a network operation can comprise at least one of a Paging Early Indication, PEI, the Paging Early Indication, PEI, with a user equipment, UE, identifier, UEID, based sub grouping; extended discontinuous reception, eDRX; a Wake Up Signal, WUS; or a Group Wake up Signal, GWUS. In an embodiment, the use of a network operation, such as a network operation configured to effect paging of a UE, can be enabled, disabled or reenabled by a CN, such as a CN function in a mobile telecommunication network, but can equally be applied for eDRX through similar indications such as an “eDRX Usage Indicator” in a paging message or a downlink (DL) non-access stratum (NAS) transfer message when an emergency PDU session is active in a synchronous manner to avoid interoperability problems and to reduce latency. As such, a network apparatus, such as a node or base station (e.g., a gNB or eNB) can be made aware that a paging function, such as PEI for example, should be disabled (e.g., due to an active emergency PDU session), or enabled or re-enabled (e.g., due to termination of an emergency PDU session).

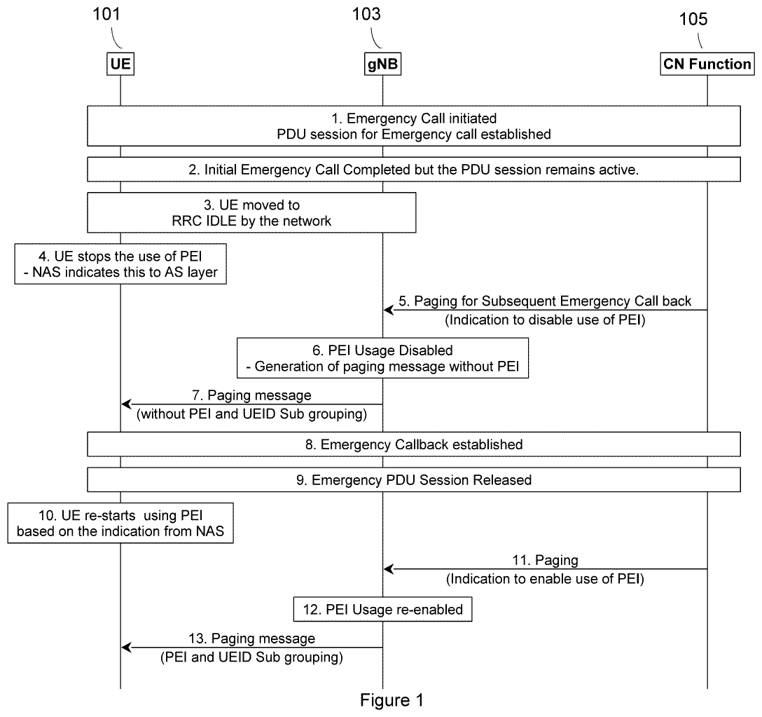

FIG. 1 is a communication flow according to an embodiment between a UE, at least one core network function of a telecommunications network and at least one network node of the telecommunications network. In the example of FIG. 1, an emergency call is initiated (1) by UE 101 and an emergency PDU (or, e.g., Evolved Universal Terrestrial Radio Access Network, E-UTRAN, Radio Access Bearer, E-RAB) session for the emergency call is established by the CN function 105 of the network for the emergency call. The CN function 105 can comprise, for example, an access mobility function (AMF) or a mobility management entity (MME) for the network.

When the initial emergency call is completed, the emergency PDU session remains active (2). That is, the emergency PDU session is not terminated by the CN function 105. The network apparatus 103, such as a gNB for example, moves the UE 101 into an RRC IDLE state of operation (3) as a result of completion of the emergency call. The UE 101 stops the use of a network operation. That is, in an embodiment, the UE 101 stops the use of paging early indication, PEI and the non-access stratum indicates this to the access stratum layer of the network.

Paging for a subsequent emergency call back, as part of the active emergency PDU session, is performed (5) by the CN function 105 of the network. As part of a paging message, data comprising an indication to disable, enable or reenable the use of at least one network operation of the network apparatus 103 for UE 101 can be provided. In the example of FIG. 1, the paging message can comprise data comprising an indication to disable the use of PEI, as a result of which the network apparatus 103 can disable the use of PEI and generate a paging message for UE 101 without an indication to use PEI. That is, the network apparatus 103 can transmit (7), to the UE 101, a paging message as part of the PDU (or Evolved Universal Terrestrial Radio Access Network, E-UTRAN, Radio Access Bearer, E-RAB) session for the emergency call, wherein the paging message is transmitted without a paging early indication, PEI, and/or a user equipment, UE, identifier, UEID, relating to a sub-grouping for the user equipment, UE. Emergency callback(s) can be established with the UE 101 (8), and, once this is complete/terminated, the emergency PDU session can be released (9). Accordingly, UE 101 can restart using PEI based on an indication (10) from the NAS relating to release of the emergency PDU session. That is, the UE 101 and the network function 105 are aware of the release. However, at this point, the network apparatus 103 is not. As such, the network function 105 can transmit (11) a paging message to the network apparatus 103 including data representing an indication that the use of PEI should be enabled (or re-enabled or as the case may be). The network apparatus 103 thus re-enables (12) the use of PEI, and a paging message is transmitted to the UE 101 from the network apparatus 103 (13) using data representing PEI and UEID subgrouping information.

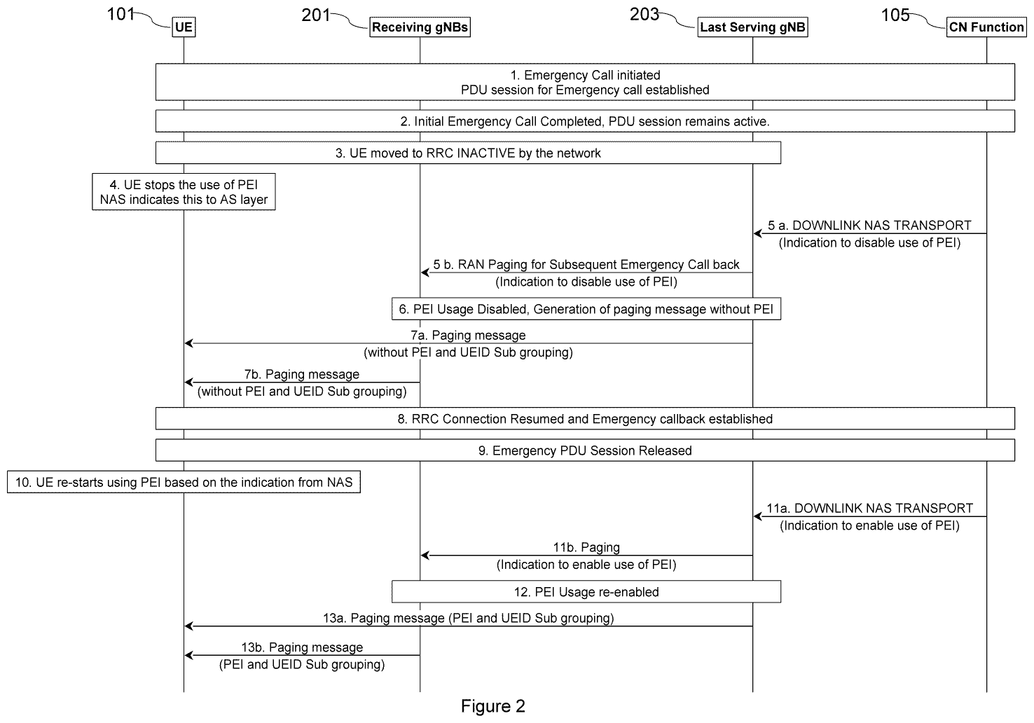

FIG. 2 is a communication flow according to an embodiment in which a CN function, such as an AMF, uses an indication in a DL NAS transport message when the CN sends the DL NAS message to a network apparatus, such as a gNB, when the UE is in an RRC INACTIVE mode of operation, which is a state of operation that is reduces the amount of time taken for the UE to transition from an RRC IDLE to an RRC CONNECTED state of operation.

In the example of FIG. 2, an emergency call is initiated (1) by UE 101 and an emergency PDU (or, e.g., or Evolved Universal Terrestrial Radio Access Network, E-UTRAN, Radio Access Bearer, E-RAB) session for the emergency call is established by the CN function 105 of the network for the emergency call. The CN function 105 can comprise, for example, an access mobility function (AMF) or a mobility management entity (MME) for the network.

When the initial emergency call is completed, the emergency PDU session remains active (2). That is, the emergency PDU session is not terminated by the CN function 105.

UE 101 is transitioned into an RRC INACTIVE state of operation (3) by the network (e.g., by a network apparatus such as a gNB) as a result of completion of the emergency call. The UE 101 stops the use of a network operation. That is, in an embodiment, the UE 101 stops the use of paging early indication, PEI and the non-access stratum indicates this to the access stratum layer of the network (4).

In the example of FIG. 2, multiple network apparatuses are involved. That is, a last serving gNB 203 and a set of receiving gNBs 201. The last serving gNB 203 comprises a network apparatus that was communicating with the UE 101 when the UE was in an RRC CONNECTED state of operation (e.g., as part of the initial emergency call) and before the transition to an RRC INACTIVE state of operation. A receiving gNB 201 is a network apparatus with which the UE 101 will communicate with when it responds to the paging. For example, the UE 101 may have moved outside of the coverage area of the last serving gNB 203 following termination of the initial emergency call.

The CN function 105 transmits (5a) a DL NAS transport message to the last serving gNB 203. The DL NAS transport message comprises information representing an indication to disable the use of PEI. Paging for a subsequent emergency call back, as part of the active emergency PDU session, is performed (5b) by the last serving gNB 203. As part of a paging message, data comprising an indication to disable, enable or reenable the use of at least one network operation of a receiving gNB 201 for UE 101 can be provided. In the example of FIG. 2, the paging message (5b) can comprise data comprising an indication to disable the use of PEI, as a result of which a receiving gNB 201 (as well as the last serving gNB 203) can disable the use of PEI (6). In the example of FIG. 2, a paging message for UE 101 can be generated without the use of PEI and transmitted to the UE 101 either by the last serving gNB (7a) and receiving gNBs 201 (7b) as appropriate. That is, a receiving gNB 201 or the last serving gNB 203 can transmit, to the UE 101, a paging message during active PDU session for the emergency call, wherein the paging message is transmitted without a paging early indication, PEI, and/or a user equipment, UE, identifier, UEID, relating to a sub-grouping for the user equipment, UE.

The RRC connection can be resumed (8). That is, the UE 101 can transition from an RRC INACTIVE to an RRC CONNECTED state of operation, and an emergency callback can be established with the UE 101 (8), and, once this is complete/terminated, the emergency PDU session can be released (9). Accordingly, UE 101 can restart using PEI based on an indication (10) from the NAS relating to release of the emergency PDU session. That is, the UE 101 and the CN function 105 are aware of the release. However, at this point, the last serving gNB 203 and the receiving gNB 201 are not. As such, the CN function 105 can transmit (11a) information as part of a DL NAS transport message to the last serving network apparatus 203 including data representing an indication that the use of PEI should be enabled (or re-enabled or as the case may be). The last serving gNB 203 can transmit a paging message (11b) including the data representing an indication that the use of PEI should be enabled (or re-enabled or as the case may be) to the receiving gNB 201. The receiving gNB 201 (and the last serving gNB 203) thus re-enables (12) the use of PEI, and a paging message using PEI and UEID subgrouping information is transmitted to the UE 101 from the last serving gNB 203 (13a) and from the receiving gNB 201 (13b).

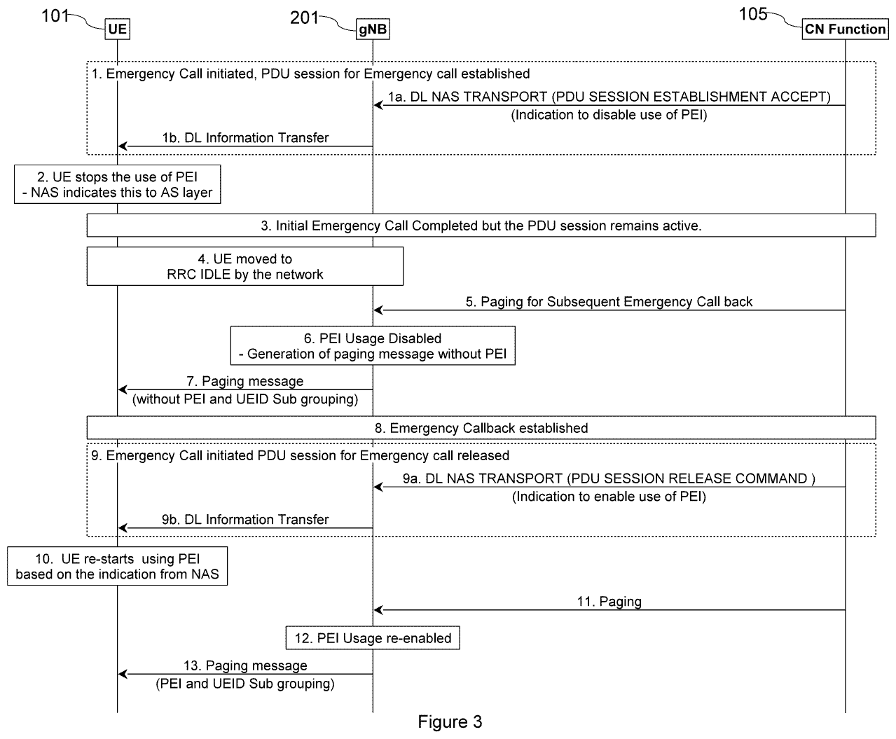

FIG. 3 is a communication flow according to an embodiment in which a CN function, such as an AMF or MME, uses an indication in a DL NAS transport message when an emergency PDU session is established or released for a UE in an RRC IDLE state of operation.

In the example of FIG. 3, an emergency call is initiated (1) by UE 101 and an emergency PDU (or, e.g., or Evolved Universal Terrestrial Radio Access Network, E-UTRAN, Radio Access Bearer, E-RAB) session for the emergency call is established by the CN function 105 of the network for the emergency call. The CN function 105 can comprise, for example, an access mobility function (AMF) or a mobility management entity (MME) for the network.

The CN function 105 transmits (1a) a DL NAS transport message (for example comprising a PDU session establishment acceptance message) to the network apparatus (gNB) 201. The DL NAS transport message comprises information representing an indication to disable the use of PEI. The gNB 201 transfers (1b) the received DL NAS message in DL Information Transfer message to the UE 101. The UE 101 stops the use of a network operation. That is, in an embodiment, the UE 101 stops the use of PEI and the non-access stratum indicates this to the access stratum layer of the network (2).

When the initial emergency call is completed, the emergency PDU session remains active (3). That is, the emergency PDU session is not terminated by the CN function 105. The gNB 201 moves the UE 101 into an RRC IDLE state of operation (4) as a result of completion of the emergency call.

Paging for a subsequent emergency call back, as part of the active emergency PDU session, is performed (5) by the CN function 105 of the network. As part of a paging message, data comprising an indication to disable, enable or reenable the use of at least one network operation of the network apparatus 103 for UE 101 can be provided. In the example of FIG. 3, the paging message can comprise data comprising an indication to disable the use of PEI, as a result of which the gNB 201 can disable the use of PEI and generate a paging message for UE 101 without the use PEI. That is, the gNB 201 can transmit (7), to the UE 101, a paging message as part of the PDU (or Evolved Universal Terrestrial Radio Access Network, E-UTRAN, Radio Access Bearer, E-RAB) session for the emergency call, wherein the paging message is transmitted without a paging early indication, PEI, and/or a user equipment, UE, identifier, UEID, relating to a sub-grouping for the user equipment, UE.

Emergency callback(s) can be established with the UE 101 (8), and, once this is complete/terminated, the emergency PDU session can be released (9). The CN function 105, as part of the release process, can transmit (9a) a DL NAS transport message (for example comprising a PDU session release command) to the gNB 201. The DL NAS transport message can include information representing an indication to enable/re-enable the use of PEI. The gNB 201 transfers (9b) the received DL NAS message to the UE 101. Accordingly, UE 101 based on the DL NAS message contents which includes a PDU session release command starts/restarts using PEI based on the indication form NAS to AS layer (10).

The CN function 105 can transmit a paging message (11) to the gNB 201, relating for example to a call that is not part of an emergency PDU session. The gNB 201 can therefore enable/reenable the use of PEI (12) for this and any subsequent paging message. The gNB 201 can transmit (13), to the UE 101, a paging message including a paging early indication, PEI, and/or a user equipment, UE, identifier, UEID, relating to a sub-grouping for the user equipment, UE.

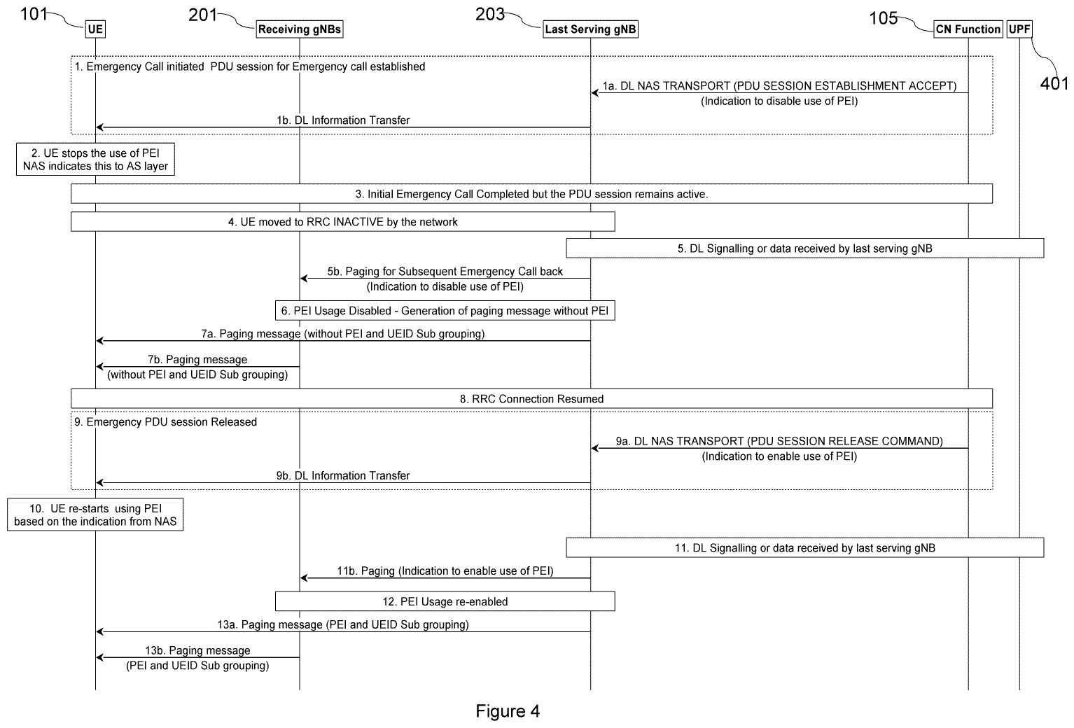

FIG. 4 is a communication flow according to an embodiment in which a CN function, such as an AMF, uses an indication in a DL NAS transport message when an emergency PDU session is established or released for a UE in an RRC INACTIVE state of operation.

In the example of FIG. 4, an emergency call is initiated (1) by UE 101 and an emergency PDU (or, e.g., or Evolved Universal Terrestrial Radio Access Network, E-UTRAN, Radio Access Bearer, E-RAB) session for the emergency call is established by the CN function 105 of the network for the emergency call. The CN function 105 can comprise, for example, an access mobility function (AMF) or Mobility Management Entity MME for the network.

The CN function 105 transmits (1a) a DL NAS transport message (comprising a PDU session establishment acceptance message) to the last serving gNB 203. The DL NAS transport message comprises information representing an indication to disable the use of PEI. The last serving gNB 203 stores this information about the disabling the use of PEI in the UE Context which represents the configuration for the UE and is maintained at the last serving gNB. The last serving gNB 203 transfers (1b) the received DL NAS message to the UE 101. The UE 101 stops the use of a network operation. That is, in an embodiment, the UE 101 stops the use of PEI and the non-access stratum of UE indicates this to the access stratum layer of the UE (2).

When the initial emergency call is completed, the emergency PDU session remains active (3). That is, the emergency PDU session is not terminated by the CN function 105. The UE 101 is transitioned into an RRC INACTIVE state of operation (4) as a result of completion of the emergency call. In the example of FIG. 4, DL signalling or data can be received by the last serving gNB 203 (5). DL Signalling can be received from the AMF and DL data can be received from the user plane function (UPF).

Paging for a subsequent emergency call back, as part of the active emergency PDU session, is performed (5b) by the last serving gNB 203. In an embodiment, the paging message (5b) is transmitted from the last serving gNB 203 to receiving gNB(s) 201. As part of a paging message, data comprising an indication to disable, enable or reenable the use of at least one network operation of the network apparatus 103 for UE 101 can be provided. In the example of FIG. 4, the paging message can comprise data comprising an indication to disable the use of PEI. Both the last serving node 203 and a receiving node 201 disable PEI (6) such that any paging message generated will not use PEI.

The last serving gNB 203 can generate a paging message for UE 101 without the use of PEI (7a) and UE ID based subgrouping. A receiving gNB 201 can generate a paging message for UE 101 without the use of PEI (7b) and UE ID based subgrouping.

That is, a receiving gNB 201 or the last serving gNB 203 can transmit, to the UE 101, a paging message as part of the PDU (or Evolved Universal Terrestrial Radio Access Network, E-UTRAN, Radio Access Bearer, E-RAB) session for the emergency call, wherein the paging message is transmitted without a paging early indication, PEI, and/or a user equipment, UE, identifier, UEID, relating to a sub-grouping for the user equipment, UE.

The RRC connection can be resumed (8) either in last serving gNB or in a receiving gNB. If the connection is resumed in the receiving gNB the UE Context will be transferred from the last serving gNB to the receiving gNB for receiving gNB to take the role of the last serving gNB over the Xn/X2 interface using UE context Retrieve procedure. That is, the UE 101 can transition from an RRC INACTIVE to an RRC CONNECTED state of operation. The emergency PDU session can be released (9). The CN function 105, as part of the release process, can transmit (9a) a DL NAS transport message (comprising a PDU session release command) to the last serving gNB 203. The DL NAS transport message can include information representing an indication to enable/re-enable the use of PEI. The last serving gNB 203 transfers (9b) the received DL NAS message to the UE 101. The NAS layer in the UE based on the contents of the message can indicate to the AS layer in the UE to start using PEI and UE ID based subgrouping. Accordingly, UE 101 starts/restarts using PEI (10). When DL signalling is received from AMF or DL, data can be received from the user plane function (UPF) by the last serving gNB 203 (11). The last serving gNB can enable/reenable the use of PEI and UE ID based subgrouping.

A paging message (11b) can be transmitted to a receiving gNB 201 from the last serving gNB 203. The paging message can include information representing an indication that the use of PEI should be enabled/reenabled. The receiving gNB 201 (and the last serving gNB 203) can therefore enable/reenable the use of PEI (12). The last serving gNB 203 can transmit (13a), to the UE 101, a paging message with a paging early indication, PEI, and a user equipment, UE, identifier, UEID, relating to a sub-grouping for the user equipment, UE. A receiving gNB 201 can transmit (13b), to the UE 101, a paging message with a paging early indication, PEI, and a user equipment, UE, identifier, UEID, relating to a sub-grouping for the user equipment, UE.

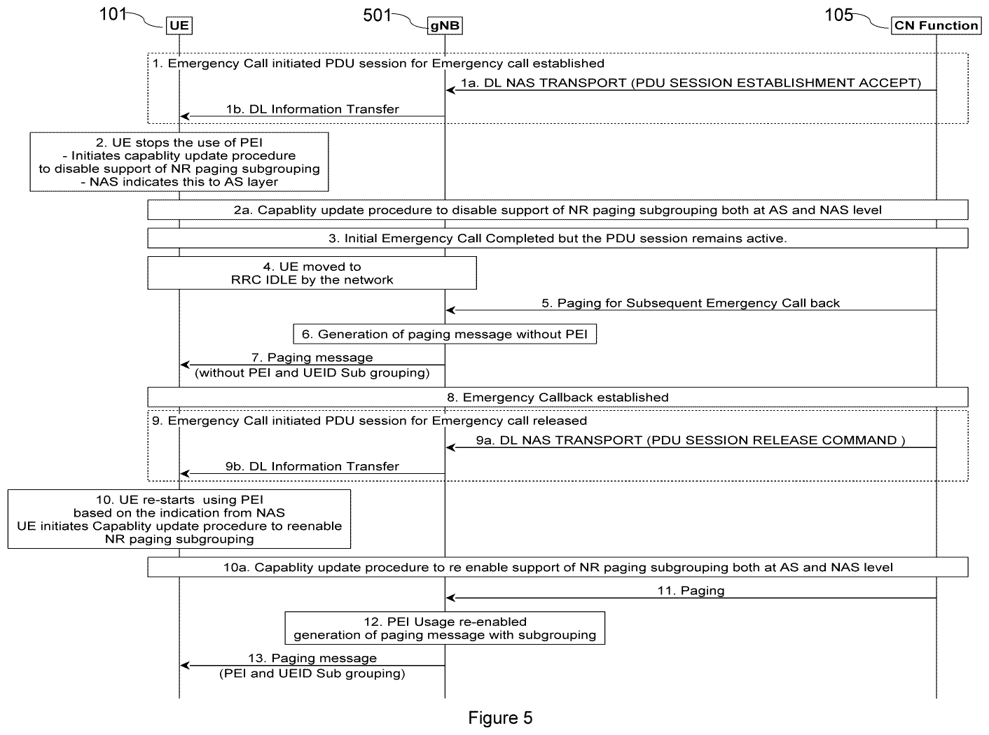

FIG. 5 is a communication flow according to an embodiment in which a UE Initiated Dynamic Capability Update is used during an emergency PDU session before the UE is transitioned into an RRC IDLE state of operation.

In the example of FIG. 5, an emergency call is initiated (1) by UE 101 and an emergency PDU (or, e.g., or Evolved Universal Terrestrial Radio Access Network, E-UTRAN, Radio Access Bearer, E-RAB) session for the emergency call is established by the CN function 105 of the network for the emergency call. The CN function 105 can comprise, for example, an access mobility function (AMF) or Mobility Management Entity (MME) for the network.

The CN function 105 transmits (1a) a DL NAS transport message (comprising a PDU session establishment acceptance message) to a gNB 501. The DL NAS transport message comprises information representing an indication to disable the use of PEI. The gNB 501 transfers (1b) the DL NAS message to the UE 101. The NAS Layer in the UE can recognise that an emergency PDU session is established and shall indicate to the AS layer. Based on such indication from the NAS to AS layer the UE 101 stops the use of a network operation. That is, in an embodiment, the UE 101 stops the use of PEI and initiates a capability update procedure to disable support of NR paging subgrouping at the AS level to the gNB and at NAS level to the core network function. In an embodiment, the UE initiates the UE capability update procedure autonomously to update its capabilities regarding PEI and sub grouping at AS level to gNB and NAS level to CN/AMF

When the initial emergency call is completed, the emergency PDU session remains active (3). That is, the emergency PDU session is not terminated by the CN function 105. The UE 101 is transitioned into an RRC IDLE state of operation (4) as a result of completion of the emergency call.

Paging for a subsequent emergency call back, as part of the active emergency PDU session, is transmitted (5) to the gNB 501 by the CN Function 105. Since the capability update procedure of the UE 101 has provided information to the AS layer and the NAS layer to disable support for NR paging subgrouping, a paging message without PEI is generated (6) by the gNB 501 and transmitted (7) to the UE 101. That is, a paging message is transmitted without a paging early indication, PEI, and/or a user equipment, UE, identifier, UEID, relating to a sub-grouping for the user equipment, UE. An emergency call back as part of the emergency PDU session can be established (8).

The emergency PDU session can be released (9). The CN function 105, as part of the release process, can transmit (9a) a DL NAS transport message (comprising a PDU session release command) to the gNB 501. The gNB 501 can forward information from the received DL NAS transport message to the UE 101 (9b). Accordingly, UE 101 re-starts using PEI based on the indication from UE NAS to UE AS layer (from 9b), and initiates a capability update procedure to reenable NR paging subgrouping (10). NR paging subgrouping is enabled at a AS level and a NAS level (10a).

A paging message (11) can be transmitted to gNB 501 from the CN function 105. As PEI is enabled/reenabled (12), gNB 501 transmits (13), to the UE 101, a paging message including a paging early indication, PEI, and/or a user equipment, UE, identifier, UEID, relating to a sub-grouping for the user equipment, UE.

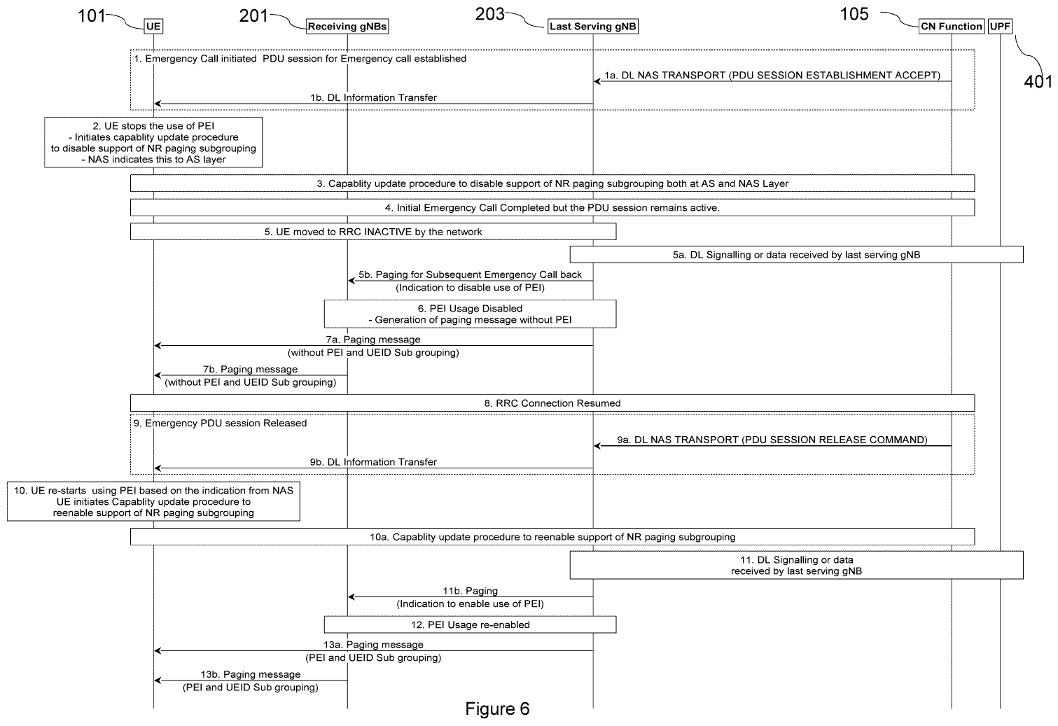

FIG. 6 is a communication flow according to an embodiment in which a UE Initiated Dynamic Capability Update is used during an emergency PDU session before the UE is transitioned into an RRC INACTIVE state of operation.

In the example of FIG. 6, an emergency call is initiated (1) by UE 101 and an emergency PDU (or, e.g., or Evolved Universal Terrestrial Radio Access Network, E-UTRAN, Radio Access Bearer, E-RAB) session for the emergency call is established by the CN function 105 of the network for the emergency call. The CN function 105 can comprise, for example, an access mobility function (AMF) or Mobility Management Entity MME for the network.

The CN function 105 transmits (1a) a DL NAS transport message (comprising a PDU session establishment acceptance message) to the last serving gNB 203. The DL NAS transport message comprises information representing an indication to disable the use of PEI. The last serving gNB 203 stores this information about the disabling the use of PEI in the UE Context which represents the configuration for the UE and is maintained at the last serving gNB. The last serving gNB 203 transfers (1b) the received DL NAS message to the UE 101. The UE 101 stops the use of a network operation. That is, in an embodiment, the UE 101 stops the use of PEI and the non-access stratum (NAS) indicates this to the access stratum (AS) layer of the UE. The UE initiates a capability update procedure to disable support of NR paging subgrouping (2) at a AS level and a NAS level.

When the initial emergency call is completed, the emergency PDU session remains active (4). That is, the emergency PDU session is not terminated by the CN function 105. The UE 101 is transitioned into an RRC INACTIVE state of operation (5) as a result of completion of the emergency call. In the example of FIG. 6, DL signalling or data can be received by the last serving gNB 203 (5a). DL Signalling can be received from the AMF and DL Data can be received from the UPF.

Paging for a subsequent emergency call back, as part of the active emergency PDU session, is performed (5b) by the last serving gNB 203. In an embodiment, the paging message (5b) is transmitted from the last serving gNB 203 to receiving gNB(s) 201. Both the last serving node 203 and a receiving node 201 disable PEI (6) such that any paging message generated will not use PEI.

The last serving gNB 203 can generate a paging message for UE 101 without the use of PEI (7a) and UE ID based subgrouping. A receiving gNB 201 can generate a paging message for UE 101 the use of PEI (7b) and UE ID based subgrouping.

That is, a receiving gNB 201 or the last serving gNB 203 can transmit, to the UE 101, a paging message as part of the PDU (or Evolved Universal Terrestrial Radio Access Network, E-UTRAN, Radio Access Bearer, E-RAB) session for the emergency call, wherein the paging message is transmitted without a paging early indication, PEI, and/or a user equipment, UE, identifier, UEID, relating to a sub-grouping for the user equipment, UE.

The RRC connection can be resumed (8) either in last serving gNB or in a receiving gNB. If the connection is resumed in the receiving gNB the UE Context will be transferred from the last serving gNB to the receiving gNB for receiving gNB to take the role of the last serving gNB over the Xn/X2 Interface using UE context Retrieve procedure. That is, the UE 101 can transition from an RRC INACTIVE to an RRC CONNECTED state of operation. The emergency PDU session can be released (9). The CN function 105, as part of the release process, can transmit (9a) a DL NAS transport message (comprising a PDU session release command) to the last serving gNB 203. The last serving gNB 203 transfers (9b) the received information to the UE 101. Accordingly, UE 101 re-starts using PEI based on the indication from NAS (from 9b), and initiates a capability update procedure to reenable NR paging subgrouping (10). NR paging subgrouping is enabled at a AS level and a NAS level (10a). When DL signalling is received from AMF or DL, data can be received from the UPF by the last serving gNB 203 (11). The last serving gNB can enable/reenable the use of PEI and UE ID based subgrouping.

A paging message (11b) can be transmitted to a receiving gNB 201 from the last serving gNB 203. The paging message can include information representing an indication that the use of PEI should be enabled/reenabled. The receiving gNB 201 (and the last serving gNB 203) can therefore enable/reenable the use of PEI (12). The last serving gNB 203 can transmit (13a), to the UE 101, a paging message with a paging early indication, PEI, and a user equipment, UE, identifier, UEID, relating to a sub-grouping for the user equipment, UE. A receiving gNB 201 can transmit (13b), to the UE 101, a paging message with a paging early indication, PEI, and a user equipment, UE, identifier, UEID, relating to a sub-grouping for the user equipment, UE.

Examples in the present disclosure can be provided as procedures, methods, systems or machine-readable instructions, such as any combination of software, hardware, firmware or the like. Such machine-readable instructions may be included on a computer readable storage medium (including but not limited to disc storage, CD-ROM, optical storage, etc.) having computer readable program codes therein or thereon.

The present disclosure is described with reference to flow charts and/or block diagrams of the method, devices and systems according to examples of the present disclosure. Although the flow diagrams described above show a specific order of execution, the order of execution may differ from that which is depicted. Blocks described in relation to one flow chart may be combined with those of another flow chart. In some examples, some blocks of the flow diagrams may not be necessary and/or additional blocks may be added. It shall be understood that each flow and/or block in the flow charts and/or block diagrams, as well as combinations of the flows and/or diagrams in the flow charts and/or block diagrams can be realized by machine readable instructions.

The machine-readable instructions may, for example, be executed by a machine such as a general-purpose computer, a platform comprising user equipment such as a smart device, e.g., a smart phone, a special purpose computer, an embedded processor or processors of other programmable data processing devices to realize the functions described in the description and diagrams. In particular, a processor or processing apparatus may execute the machine-readable instructions. Thus, modules of apparatus may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate set etc. The methods and modules may all be performed by a single processor or divided amongst several processors.

Such machine-readable instructions may also be stored in a computer readable storage that can guide the computer or other programmable data processing devices to operate in a specific mode. For example, the instructions may be provided on a non-transitory computer readable storage medium encoded with instructions, executable by a processor.

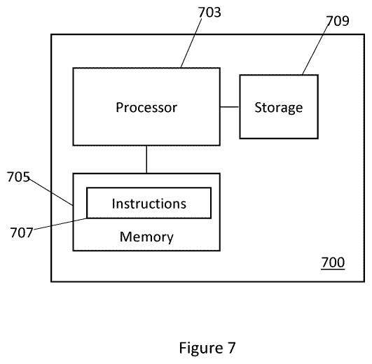

FIG. 7 is a schematic representation of a machine according to an embodiment. The machine 600 can be, e.g., a system or apparatus, user equipment, or part thereof (e.g., a network apparatus, core network apparatus, or UE). The machine 700 comprises a processor 703, and a memory 705 to store instructions 707, executable by the processor 703. The machine comprises a storage 709 that can be used to store data.

The instructions 707, executable by the processor 703, can cause the machine 700, which can be a network apparatus for example, to receive data comprising an indication to disable, enable or reenable the use of at least one network operation of the network apparatus for a user equipment, UE, wherein the user equipment, UE, is in a radio resource control, RRC, idle or inactive state of operation, and wherein the user equipment, UE, is participating in an active Packet Data Unit, PDU, or Evolved Universal Terrestrial Radio Access Network, E-UTRAN, Radio Access Bearer, E-RAB, session for an emergency call, and use the received data to disable, enable or reenable the at least one network operation.

Accordingly, the machine 700 can implement a method for disabling, enabling or reenabling the use of at least one network operation, such as a paging operation, of the network apparatus for a user equipment, UE, during an emergency PDU session.

Such machine-readable instructions may also be loaded onto a computer or other programmable data processing devices, so that the computer or other programmable data processing devices perform a series of operations to produce computer-implemented processing, thus the instructions executed on the computer or other programmable devices provide an operation for realizing functions specified by flow(s) in the flow charts and/or block(s) in the block diagrams.

Further, the teachings herein may be implemented in the form of a computer or software product, such as a non-transitory machine-readable storage medium, the computer software or product being stored in a storage medium and comprising a plurality of instructions, e.g., machine readable instructions, for making a computer device implement the methods recited in the examples of the present disclosure.

In some examples, some methods can be performed in a cloud-computing or network-based environment. Cloud-computing environments may provide various services and applications via the Internet. These cloud-based services (e.g., software as a service, platform as a service, infrastructure as a service, etc.) may be accessible through a web browser or other remote interface of the user equipment for example. Various functions described herein may be provided through a remote desktop environment or any other cloud-based computing environment.

While various embodiments have been described and/or illustrated herein in the context of fully functional computing systems, one or more of these exemplary embodiments may be distributed as a program product in a variety of forms, regardless of the particular type of computer-readable-storage media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the exemplary embodiments disclosed herein. In addition, one or more of the modules described herein may transform data, physical devices, and/or representations of physical devices from one form to another.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

1. A network apparatus in a telecommunications network, wherein the telecommunications network comprises at least one core network and at least one network node, the network apparatus configured to:
receive data comprising an indication to disable, enable or reenable the use of at least one network operation of the network apparatus for a user equipment (UE), wherein the UE is in a radio resource control (RRC) idle or inactive state of operation, and wherein the UE is participating in an active Packet Data Unit (PDU) or Evolved Universal Terrestrial Radio Access Network (E-UTRAN) Radio Access Bearer (E-RAB) session for an emergency call; and
use the received data to disable, enable or reenable the at least one network operation.

2. The network apparatus of claim 1, wherein the network operation comprises at least one of a Paging Early Indication (PEI), the PEI comprising a UE identifier (UEID) based sub grouping; extended discontinuous reception (eDRX); a Wake Up Signal (WUS); or a Group Wake up Signal (GWUS).

3. The network apparatus of claim 1, wherein the network apparatus is configured to receive the data from the at least one core network of the telecommunications network or from the at least one network node.

4. The network apparatus of claim 3, wherein the network apparatus is further configured to receive the data from the at least one core network of the telecommunications network as part of a paging message.

5. The network apparatus of claim 4, wherein the network apparatus is further configured to receive the data from the at least one core network of the telecommunications network as part of a paging message for an emergency call back to be received by the UE as part of the active PDU or E-RAB session for an emergency call.

6. The network apparatus of claim 1, wherein the network apparatus is further configured to:
transmit, to the UE, a paging message as part of the PDU or E-RAB session for the emergency call, wherein the paging message is transmitted without a PEI and/or a UE identifier (UEID) relating to a sub-grouping for the UE.

7. The network apparatus of claim 1, wherein the data comprises part of a downlink (DL) non-access stratum (NAS) message from at least one core network of the telecommunications network.

8. The network apparatus of claim 7, wherein the network apparatus is further configured to receive the data comprising an indication to disable the use of PEI, extended discontinuous reception (eDRX), a wake-up signal (WUS), or a Group Wake up Signal (GWUS) for the UE when establishing the emergency call for the UE as part of a PDU or E-RAB session acceptance message transmitted by the at least one core network of the telecommunications network.

9. The network apparatus of claim 7, wherein the network apparatus is configured to receive the data comprising an indication to reenable the use of PEI, extended discontinuous reception (eDRX), a wake-up signal (WUS), or a Group Wake up Signal (GWUS) for the UE when releasing the emergency call for the UE as part of a PDU or E-RAB session release message transmitted by the at least one core network of the telecommunications network.

10. The network apparatus of claim 1, wherein the network apparatus comprises a functionally split network apparatus comprising a central unit (CU) and a distribution unit (DU), wherein the network apparatus is configured to receive the data from the at least one core network of the telecommunications network using a F1 interface configured between the CU and the DU.

11. A core network apparatus of a telecommunications network, wherein the telecommunications network comprises at least one core network and at least one network node, the core network apparatus configured to:
transmit, to a network apparatus of the telecommunications network, data comprising an indication to disable, enable or reenable use of at least one network operation for a use equipment (UE), wherein the UE is in a radio resource control (RRC) idle or inactive state of operation, and wherein the UE is participating in an active session for an emergency call.

12. The core network apparatus of claim 11, wherein the active session for an emergency call comprises an active Packet Data Unit (PDU) or Evolved Universal Terrestrial Radio Access Network (E-UTRAN) Radio Access Bearer (E-RAB) session for an emergency call, and wherein the network operation comprises at least one of a paging early indication (PEI), the PEI comprising a UE identifier (UEID) based sub grouping; extended discontinuous reception (eDRX); a Wake Up Signal (WUS); or a Group Wake up Signal (GWUS).

13. The core network apparatus of claim 12, wherein the core network apparatus is configured to transmit the data as part of a paging message for an emergency call back to be received by the UE as part of the PDU or E-RAB session for an emergency call.

14. The core network apparatus of claim 11, wherein the core network apparatus is configured to transmit the data comprising an indication to disable, enable, or reenable the at least one network operation as part of a downlink (DL) non-access stratum (NAS) message.

15. User equipment (UE), wherein the UE is participating in an active Packet Data Unit (PDU) or Evolved Universal Terrestrial Radio Access Network (E-UTRAN) Radio Access Bearer (E-RAB) session for an emergency call, the UE configured to:
receive data from a network apparatus in a telecommunications network, wherein the telecommunications network comprises at least one core network and at least one network node, the data representing an indication of an establishment or release of the emergency call; and
transmit data, to the at least one core network of the telecommunications network and to the at least one network node, to disable or enable the use of paging early indication and paging subgrouping for the UE, the data provided as part of a UE capability information message.
